(19) United States
(12) Patent Application Publication
(10) Pub. No.: US 2024/0028500 A1
(43) Pub. Date: Jan. 25, 2024

(54) GENERATING TESTING PLANS INCLUDING EXECUTION ORDER FOR TEST CASES AND MAPPING OF TEST CASES TO TEST BED POOLS

(71) Applicant: Dell Products L.P., Round Rock, TX (US)

(72) Inventors: Fang Du, Guangyuan (CN); Xu Chen, Chengdu (CN); Huijuan Fan, Chengdu (CN)

(21) Appl. No.: 17/882,858

(22) Filed: Aug. 8, 2022

(30) Foreign Application Priority Data
Jul. 25, 2022 (CN) 202210879401.3

(51) Int. Cl. G06F 11/36

(52) U.S. Cl. CPC G06F 11/3684; G06F 11/3688

(57) ABSTRACT

An apparatus comprises a processing device configured to identify test cases and test beds on which the test cases are configured to run, and to create test bed pools each associated with one of the test cases and comprising at least one of the test beds. The processing device is also configured to determine priority levels of the test cases and dependency degrees of the test beds. The processing device is further configured to generate a testing plan for testing a given product, the testing plan comprising a test case execution order for the test cases and a mapping of the test cases to the test beds, the test case execution order being determined based on the priority levels and the mapping of the test cases to the test beds being determined based on the dependency degrees. The processing device is further configured to execute the testing plan.

### RELATED APPLICATION

The present application claims priority to Chinese Patent Application No. 202210879401.3, filed on Jul. 25, 2022 and entitled “Apparatus and Method for Generating Testing Plans,” which is incorporated by reference herein in its entirety.

### FIELD

The field relates generally to information processing, and more particularly to management of information processing systems.

### BACKGROUND

Software development processes typically include multiple environments, such as one or more development environments, an integration testing environment, a staging environment, and a production environment. New software code may be created by individual developers or small teams of developers in respective ones of the development environments. The integration environment provides a common environment where software code from the multiple developers is combined and tested before being provided to the staging environment. The staging environment is designed to emulate the production environment and may be used for final review and approval before new software code is deployed in production applications in the production environment.

### SUMMARY

Illustrative embodiments of the present disclosure provide techniques for generating testing plans including execution order for test cases and mapping of test cases to test bed pools.

In one embodiment, an apparatus comprises at least one processing device comprising a processor coupled to a memory. The at least one processing device is configured to perform the steps of identifying a plurality of test cases and a plurality of test beds on which the plurality of test cases are configured to run, the plurality of test beds comprising information technology assets of an information technology infrastructure, and creating a plurality of test bed pools, wherein each of the plurality of test bed pools is associated with one of the plurality of test cases and comprises at least one of the plurality of test beds, and wherein a given one of the plurality of test bed pools associated with a given one of the plurality of test cases comprises at least a subset of the plurality of test beds having test bed configurations matching one or more test bed specifications of the given test case. The at least one processing device is also configured to perform the steps of determining a priority level of each of the plurality of test cases, wherein a given priority level of the given test case is determined based at least in part on one or more test case property specifications of the given test case, and determining a dependency degree of each of the plurality of test beds, wherein a given dependency degree for a given one of the plurality of test beds is determined based at least in part on a number of the plurality of test bed pools that the given test bed is part of. The at least one processing device is further configured to perform the step of generating a testing plan for testing a given product, the testing plan comprising a test case execution order for the plurality of test cases and a mapping of the plurality of test cases to the plurality of test beds, wherein the test case execution order is determined based at least in part on the priority levels of the plurality of test cases, and wherein the mapping of the plurality of test cases to the plurality of test beds is determined based at least in part on the dependency degrees of the plurality of test beds. The at least one processing device is further configured to perform the step of executing the testing plan for testing the given product.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for generating testing plans including execution order for test cases and mapping of test cases to test bed pools in an illustrative embodiment.

FIG. 2 is a flow diagram of an exemplary process for generating testing plans including execution order for test cases and mapping of test cases to test bed pools in an illustrative embodiment.

FIG. 3 shows a table of test execution statistics for a storage system testing plan in an illustrative embodiment.

FIG. 4 shows a mapping of test cases to test beds in an illustrative embodiment.

FIG. 5 shows a mapping of test cases to test bed pools in an illustrative embodiment.

FIG. 6 shows a process flow for creating test bed pools in an illustrative embodiment.

FIG. 7 shows test bed tags and test case property tags which are used in mapping test cases to test bed pools in an illustrative embodiment.

FIG. 8 shows a process flow for generating a test execution plan in an illustrative embodiment.

FIG. 9 shows a test execution map generated using the FIG. 8 process flow in an illustrative embodiment.

FIG. 10 shows a process flow for generating and executing a testing plan in an illustrative embodiment.

FIG. 11 shows an analytic hierarchy process architecture used for calculating weights of test case property tags in an illustrative embodiment.

FIG. 12 shows a plot of weight update trends for test case property tags during a test life cycle in an illustrative embodiment.

FIG. 13 shows a test execution table for test cases that is generated using test case priority and test bed dependency degree features in an illustrative embodiment.

FIG. 14 shows a test case execution order for a set of test cases mapped to test beds in an illustrative embodiment.

FIGS. 15 and 16 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

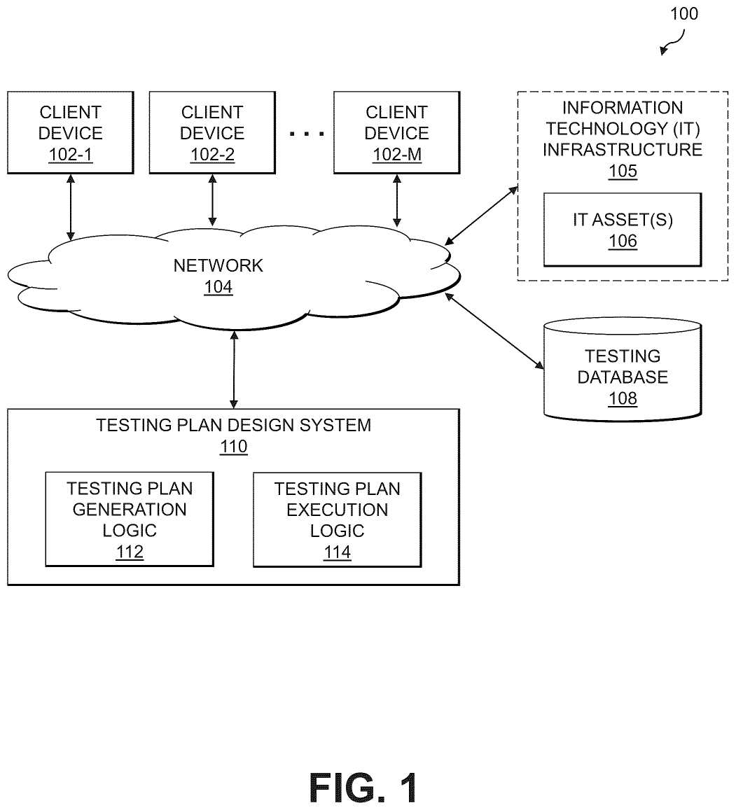

FIG. 1 shows an information processing system 100 configured in accordance with an illustrative embodiment. The information processing system 100 is assumed to be built on at least one processing platform and provides functionality for generating testing plans for testing of information technology (IT) assets. The information processing system 100 includes a set of client devices 102-1, 102-2, . . . 102-M (collectively, client devices 102) which are coupled to a network 104. Also coupled to the network 104 is an IT infrastructure 105 comprising one or more IT assets 106, a testing database 108, and a testing plan design system 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

The IT assets 106 of the IT infrastructure 105 may host applications that are utilized by respective ones of the client devices 102, such as in accordance with a client-server computer program architecture. In some embodiments, the applications comprise web applications designed for delivery from assets in the IT infrastructure 105 to users (e.g., of client devices 102) over the network 104. Various other examples are possible, such as where one or more applications are used internal to the IT infrastructure 105 and not exposed to the client devices 102. It should be appreciated that, in some embodiments, some of the IT assets 106 of the IT infrastructure 105 may themselves be viewed as applications or more generally software or hardware that is to be tested. For example, ones of the IT assets 106 that are virtual computing resources implemented as software containers may represent software that is to be tested. As another example, ones of the IT assets 106 that are physical computing resources may represent hardware devices that are to be tested.

The testing plan design system 110 utilizes various information stored in the testing database 108 in designing testing plans for use in testing the IT assets 106, applications or other software running on the IT assets 106, etc. In some embodiments, the testing plan design system 110 is used for an enterprise system. For example, an enterprise may subscribe to or otherwise utilize the testing plan design system 110 for generating and running testing plans (e.g., on the IT assets 106 of the IT infrastructure 105, on client devices 102 operated by users of the enterprise, etc.). As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different business, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The testing database 108, as discussed above, is configured to store and record various information that is used by the testing plan design system 110 in designing testing plans for use in testing the IT assets 106, applications or other software running on the IT assets 106. Such information may include, but is not limited to, information regarding test bed requirements for different test cases (e.g., where the test bed requirements represent hardware, software and configuration requirements or other limitations for where test cases may be run), information regarding test case properties for different test cases (e.g., representing factors or criteria that may be used in determining a prioritization among different test cases), etc. The testing database 108 in some embodiments is implemented using one or more storage systems or devices associated with the testing plan design system 110. In some embodiments, one or more of the storage systems utilized to implement the testing database 108 comprises a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the testing plan design system 110, as well as to support communication between the testing plan design system 110 and other related systems and devices not explicitly shown.

The client devices 102 are configured to access or otherwise utilize the IT infrastructure 105. In some embodiments, the client devices 102 are assumed to be associated with system administrators, IT managers or other authorized personnel responsible for managing the IT assets 106 of the IT infrastructure 105 (e.g., where such management includes performing testing of the IT assets 106, or of applications or other software that runs on the IT assets 106). For example, a given one of the client devices 102 may be operated by a user to access a graphical user interface (GUI) provided by the testing plan design system 110 to manage testing plans (e.g., create, review, execute, etc.). The testing plan design system 110 may be provided as a cloud service that is accessible by the given client device 102 to allow the user thereof to manage testing plans. In some embodiments, the IT assets 106 of the IT infrastructure 105 are owned or operated by the same enterprise that operates the testing plan design system 110 (e.g., where an enterprise such as a business provides support for the assets it operates). In other embodiments, the IT assets 106 of the IT infrastructure 105 may be owned or operated by one or more enterprises different than the enterprise which operates the testing plan design system 110 (e.g., a first enterprise provides support for assets that are owned by multiple different customers, business, etc.). Various other examples are possible.

In other embodiments, the testing plan design system 110 may provide support for testing of the client devices 102, instead of or in addition to providing support for the IT assets 106 of the IT infrastructure 105. For example, the testing plan design system 110 may be operated by a hardware vendor that manufactures and sells computing devices (e.g., desktops, laptops, tablets, smartphones, etc.), and the client devices 102 represent computing devices sold by that hardware vendor. The testing plan design system 110 may also or alternatively be operated by a software vendor that produces and sells software (e.g., applications) that runs on the client devices 102. The testing plan design system 110, however, is not required to be operated by any single hardware or software vendor. Instead, the testing plan design system 110 may be offered as a service to provide support for computing devices or software that are sold by any number of hardware or software vendors. The client devices 102 may subscribe to the testing plan design system 110, so as to provide support for testing of the client devices 102 or software running thereon, for testing hardware or software products that are to be deployed as the IT assets 106 and/or the client devices 102, etc. Various other examples are possible.

In some embodiments, the client devices 102 may implement host agents that are configured for automated transmission of information regarding test cases, test beds and test case execution (e.g., test bed tags and test case property tags as discussed in further detail below, results of test case attempts, etc. which are periodically provided to the testing database 108 and/or the testing plan design system 110). Such host agents may also or alternatively be configured to automatically receive from the testing plan design system 110 commands to execute remote actions (e.g., to run various testing plans or portions thereof on the client devices 102 and/or the IT assets 106 of the IT infrastructure 105, such as instructions to attempt test cases on particular test beds hosted on the client devices 102 and/or the IT assets 106 of the IT infrastructure 105). Host agents may similarly be deployed on the IT assets 106 of the IT infrastructure 105.

It should be noted that a “host agent” as this term is generally used herein may comprise an automated entity, such as a software entity running on a processing device. Accordingly, a host agent need not be a human entity.

The testing plan design system 110 in the FIG. 1 embodiment is assumed to be implemented using at least one processing device. Each such processing device generally comprises at least one processor and an associated memory, and implements one or more functional modules or logic for controlling certain features of the testing plan design system 110. In the FIG. 1 embodiment, the testing plan design system 110 comprises testing plan generation logic 112 and testing plan execution logic 114. The testing plan generation logic 112 is configured to create test bed pools for different test cases (e.g., using test bed tags that specify hardware, software and configuration requirements and other limitations on which test beds different test cases are able to run on), and to determine mappings between test cases and test bed pools. The testing plan generation logic 112 is further configured to determining an ordering and prioritization of test cases, where such prioritization is taken into account to assign test cases to specific test beds in the test cases' associated test bed pools. The testing plan execution logic 114 is configured to execute the testing plans generated using the testing plan generation logic 112 (e.g., on one or more of the IT assets 106 of the IT infrastructure 105, on client devices 102, combinations thereof which provide test beds on which test cases may be executed, etc.).

It is to be appreciated that the particular arrangement of the client devices 102, the IT infrastructure 105 and the testing plan design system 110 illustrated in the FIG. 1 embodiment is presented by way of example only, and alternative arrangements can be used in other embodiments. As discussed above, for example, the testing plan design system 110 (or portions of components thereof, such as one or more of the testing plan generation logic 112 and the testing plan execution logic 114) may in some embodiments be implemented internal to one or more of the client devices 102 and/or the IT infrastructure 105.

At least portions of the testing plan generation logic 112 and the testing plan execution logic 114 may be implemented at least in part in the form of software that is stored in memory and executed by a processor.

The testing plan design system 110 and other portions of the information processing system 100, as will be described in further detail below, may be part of cloud infrastructure.

The testing plan design system 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the testing database 108 and the testing plan design system 110 or components thereof (e.g., the testing plan generation logic 112 and the testing plan execution logic 114) may be implemented on respective distinct processing platforms, although numerous other arrangements are possible. For example, in some embodiments at least portions of the testing plan design system 110 and one or more of the client devices 102, the IT infrastructure 105 and/or the testing database 108 are implemented on the same processing platform. A given client device (e.g., 102-1) can therefore be implemented at least in part within at least one processing platform that implements at least a portion of the testing plan design system 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the testing database 108 and the testing plan design system 110, or portions or components thereof, to reside in different data centers. Numerous other distributed implementations are possible. The testing plan design system 110 can also be implemented in a distributed manner across multiple data centers.

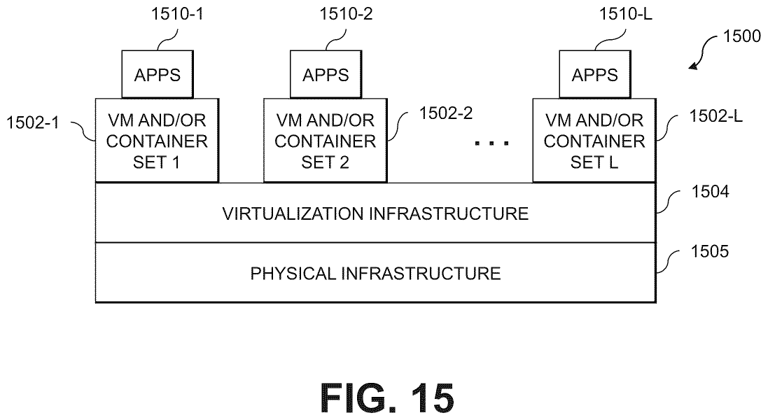

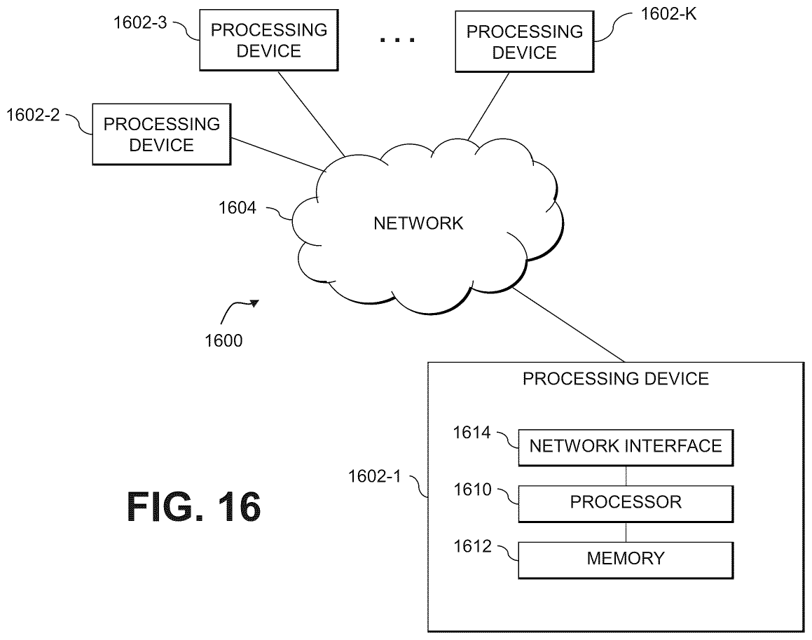

Additional examples of processing platforms utilized to implement the testing plan design system 110 and other components of the information processing system 100 in illustrative embodiments will be described in more detail below in conjunction with FIGS. 15 and 16.

It is to be appreciated that these and other features of illustrative embodiments are presented by way of example only, and should not be construed as limiting in any way.

It is to be understood that the particular set of elements shown in FIG. 1 for generating testing plans including execution order for test cases and mapping of test cases to test bed pools is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

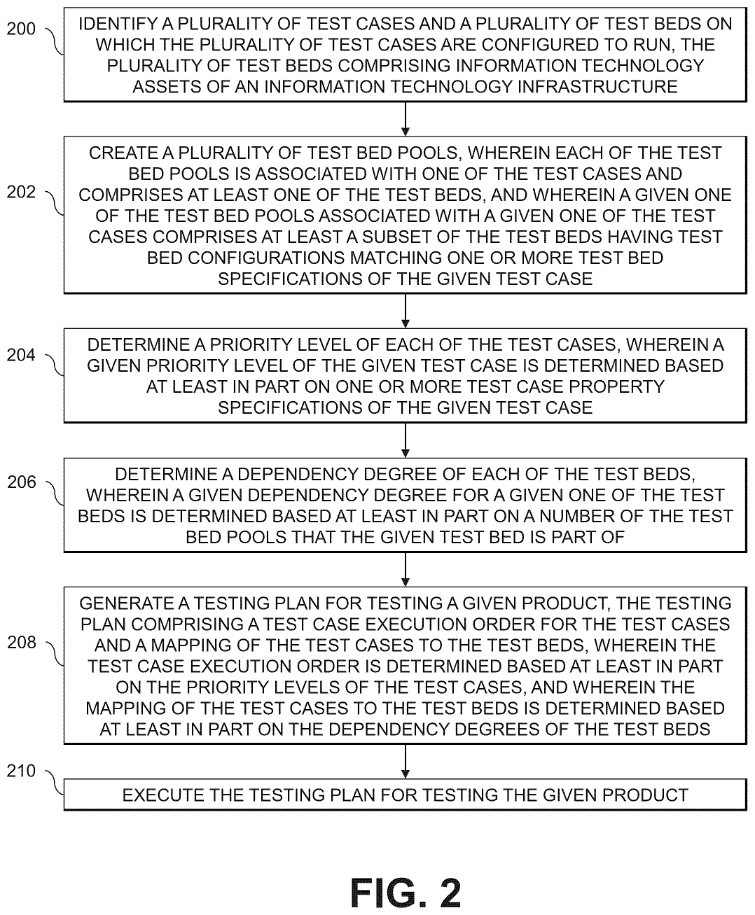

An exemplary process for generating testing plans including execution order for test cases and mapping of test cases to test bed pools will now be described in more detail with reference to the flow diagram of FIG. 2. It is to be understood that this particular process is only an example, and that additional or alternative processes for generating testing plans including execution order for test cases and mapping of test cases to test bed pools may be used in other embodiments.

In this embodiment, the process includes steps 200 through 210. These steps are assumed to be performed by the testing plan design system 110 utilizing the testing plan generation logic 112 and the testing plan execution logic 114. The process begins with step 200, identifying a plurality of test cases and a plurality of test beds on which the plurality of test cases are configured to run, the plurality of test beds comprising IT assets of an IT infrastructure.

A plurality of test bed pools are created in step 202. Each of the plurality of test bed pools is associated with one of the plurality of test cases and comprises at least one of the plurality of test beds. A given one of the plurality of test bed pools associated with a given one of the plurality of test cases comprises at least a subset of the plurality of test beds having test bed configurations matching one or more test bed specifications of the given test case. A given test bed configuration for a given one of the plurality of test beds comprises at least one of a hardware and a software configuration of a given one of the IT assets of the IT infrastructure on which the given test bed runs. The one or more test bed specifications of the given test case may comprise at least one of one or more hardware configuration requirements and one or more software configuration requirements.

In step 204, a priority level of each of the plurality of test cases is determined. A given priority level of the given test case is determined based at least in part on one or more test case property specifications of the given test case. The one or more test case property specifications of the given test case may specify a type of testing performed during the given test case. The type of testing may comprise at least one of regression testing, new feature coverage testing, and benchmark testing. The one or more test case property specifications of the given test case may also or alternatively specify one or more results of previous attempts to perform the given test case. The one or more results of the previous attempts to perform the given test case may indicate at least one of: whether the given test case has passed during the previous attempts to perform the given test case; and bugs encountered during the previous attempts to perform the given test case.

The given priority level for the given test case may be determined as a weighted average of weights assigned to the one or more test case property specifications. The given priority level may be determined utilizing a time-based analytic hierarchy process which takes into account a current one of a plurality of testing stages of a test life cycle of the testing plan. The weight values assigned to the one or more test case property tag specifications may be dynamically updated at different ones of the plurality of testing stages of the test life cycle of the testing plan. The time-based analytic hierarchy process may utilize a dynamic judgment matrix, and the weighted average may be computed by determining a geometric mean of each row vector of the dynamic judgment matrix and normalizing the weight values of the one or more test case property specifications.

The FIG. 2 process continues with step 206, determining a dependency degree of each of the plurality of test beds. A given dependency degree for a given one of the plurality of test beds is determined based at least in part on a number of the plurality of test bed pools that the given test bed is part of A testing plan for testing a given product is generated in step 208. The given product may comprise software configured to run on IT assets of an IT infrastructure. The testing plan comprises a test case execution order for the plurality of test cases and a mapping of the plurality of test cases to the plurality of test beds. The test case execution order is determined based at least in part on the priority levels of the plurality of test cases. The mapping of the plurality of test cases to the plurality of test beds is determined based at least in part on the dependency degrees of the plurality of test bed. Step 208 may comprise normalizing the priority levels and the dependency degrees utilizing a Z-score normalization algorithm. Step 208 may further comprise utilizing a linear programming mathematical model comprising an objective function that comprises a weighted sum of the normalized priority levels and dependency degrees. In step 210, the testing plan for testing the given product is executed.

Test execution plays an important role in product development and release, where the products being tested may include IT assets, such as physical and virtual computing resources, firmware, software, etc. With the continuous addition of new features for products, the number of test cases required also increases. Within an organization, a project management team may formulate a testing plan and expect that all test cases in the testing plan can or will be executed or at least attempted in time (e.g., prior to product release), especially for important or high priority test cases which can impact whether the product releases on time. From test execution experience, however, it is often the case that not all test cases in a testing plan are able to be executed on time. There are various reasons that test cases in a testing plan are not able to be executed in time, including but not limited to blocking issues and environmental issues.

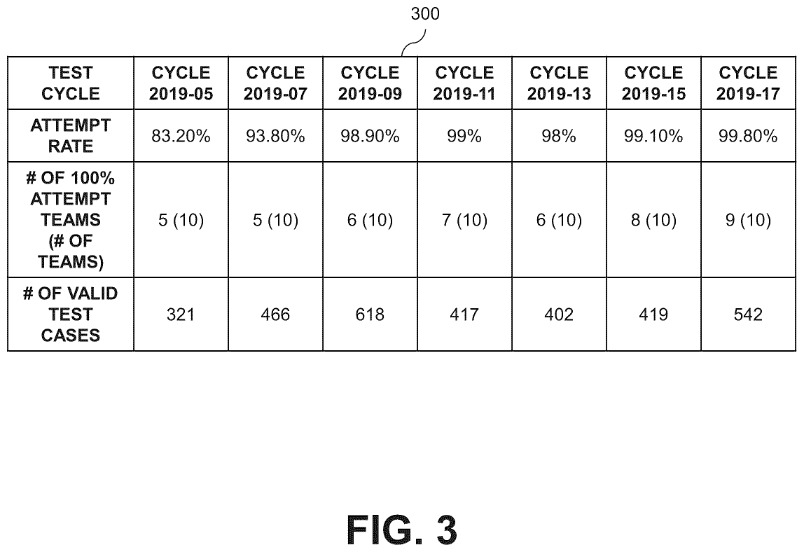

Blocking issues are typically encountered at the beginning of a test life cycle, as test cases that are executed in the early stage of product development may generate critical product problems which block or prevent execution of other test cases in later stages of product development. Environmental issues may be encountered throughout the test life cycle. Consider, as an example, storage system testing where a given test case may be executed on a given test bed which includes one or more storage products (e.g., hardware and/or software storage IT assets) and associated network configurations. Various environmental issues may happen on the given test bed, such as storage product or network interface reconfiguration, hosts being down, services being down on host restart, IO tool upgrades, etc. Test engineers can solve such environmental issues from time to time throughout the test life cycle, but this can occupy a significant amount of test execution time which can prevent some test cases in the testing plan from being attempted on time. FIG. 3 shows a table 300 of test execution statistics for a storage system testing plan that includes a number of test cycles. As illustrated in the table 300, none of the test cycles were able to attempt all test cases.

From a project management perspective, the objectives of testing include: maximizing the execution rate of test cases in a given time period; and completing test cases with higher importance or priority as early as possible. Illustrative embodiments provide technical solutions for enabling smart test execution process optimization. In some embodiments, analytic hierarchy process (AHP) and linear programming algorithms are leveraged to improve test execution from multiple stages to meet the objectives of maximizing (or at least increasing or improving) the execution rate of test cases in a given time period, and completing test cases with higher importance or priority as early as possible.

In a product development process, a project management team may arrange the execution of test cases manually in a testing plan, and then make some temporary adjustments to the scheduling of test cases in the testing plan according to project progress. The test execution team will run the tests accordingly. Such an approach, however, is not intelligent when facing blocking issues which can impact test case attempt rate, and lacks optimization of the test execution ordering and processing. The technical solutions described herein provide smart test execution process optimization approaches which can improve test execution during product development from multiple levels, including: increasing test case attempt rate by creating test bed pools for test cases; and prioritizing important test cases such that they are executed as early as possible. In some embodiments, AHP is leveraged to update test case priority dynamically along with project progress and linear programming is leveraged to generate a test case execution ordering in a testing plan.

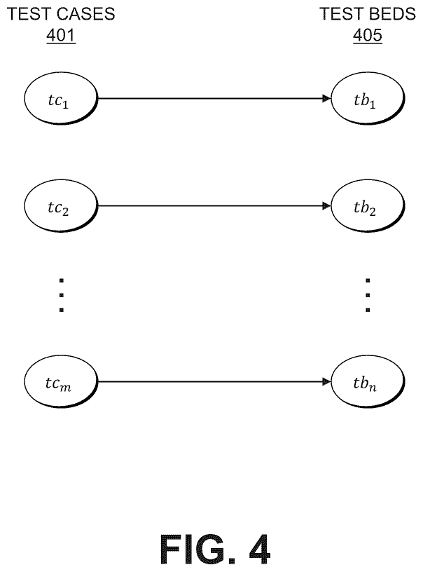

During a product development process, there are a number of test cases that need to run at each development stage. Normally, one test case reserves one test bed, and the test case releases that test bed after the test case is attempted (e.g., which may result in the test case passing or failing). FIG. 4 shows a mapping of test cases 401 to test beds 405, where there are m test cases tc₁, tc₂, . . . tcₘ and n test beds tb₁, tb₂, . . . tbₙ, where usually m≠n. Once a test case tcᵢ is attempted on test bed tbⱼ (e.g., where i≤m, j≤n), the test bed tbⱼ may be released for use by another one of the test cases. If the test bed tbⱼ is broken, then the test case tcᵢ is blocked. If the test bed tbⱼ is not recovered before the end of the testing cycle, then the final status of the test case tcᵢ will be “not attempted.” Such an approach leads to various issues. For example, in such an approach a given test case cannot be attempted once its reserved test bed is broken, even though there may be test beds available which meet the given test case's requirements. As another example, such an approach does not ensure that important test cases are executed as early as possible in the testing cycle because there is no prioritization of the test cases based on their importance.

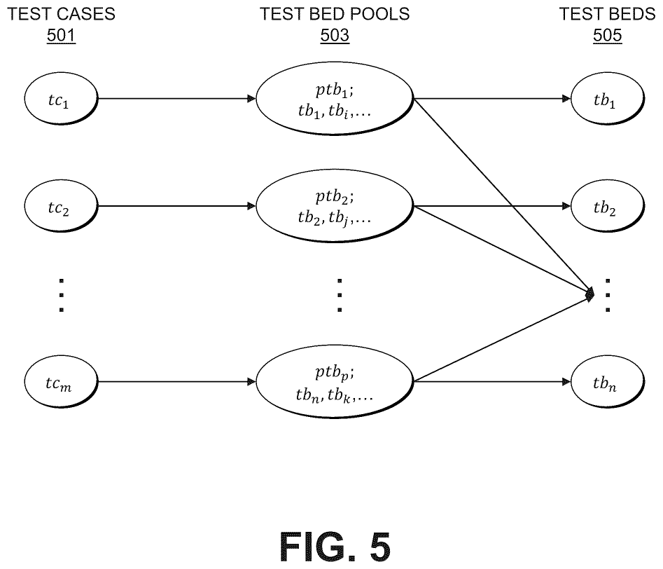

Illustrative embodiments provide technical solutions for smart test execution process optimization. To do so, some embodiments are able to refine the simple mapping relationship between test cases 401 and test beds 405 shown in FIG. 4 and improve test case execution at two levels: (1) through the creation of test bed pools; and (2) through a mechanism for smart test execution process optimization. For the first level, test bed pools are created and test cases are mapped to the test bed pools. FIG. 5 shows a mapping between test cases 501 and test bed pools 503, where each of the test bed pools 503 is assumed to include at least one of the test beds 505 (and where most of the test bed pools 503 are assumed to include multiple ones of the test beds 505). It should be noted that while FIG. 5 shows an example where each of the test bed pools 503 includes multiple test beds 505, this is not a requirement. In some cases, a test bed pool may include only a single test bed. Also, there may be overlaps among the test bed pools 503 as shown in FIG. 5. In the FIG. 5 example, there are m test cases 501, denoted tc₁, tc₂, . . . tcₘ, p test bed pools 503 denoted ptb₁, ptb₂, . . . ptbₚ, and and n test beds 505 denoted tb₁, tb₂, . . . tbₙ. Again, usually m≠n, though this is not a requirement. The size of each of the test bed pools 503 is greater than or equal to one (e.g., there is at least one of the test beds 505 in each of the test bed pools 503).

The creation of the test bed pools 503 can save considerable resources, and is efficient to implement. In practice, there are usually no or very few test cases that can only be run on one specific test bed. In other words, for any given test case, there is normally multiple different test beds on which the given test case may be attempted. When designing a test case, test bed requirements (e.g., multiple hardware, software and configuration requirements or other limitations) may be specified for the test beds on which the test case may be attempted. For example, a given test case may require 32G Fibre Channel (FC) installed on a target storage product. Thus, if a given test bed has 32G FC installed, the given test bed matches the test bed requirements of the given test case and can be added to the given test case's test bed pool. It should be appreciated that test cases may have multiple test bed requirements (e.g., multiple hardware, software and configuration requirements or other limitations).

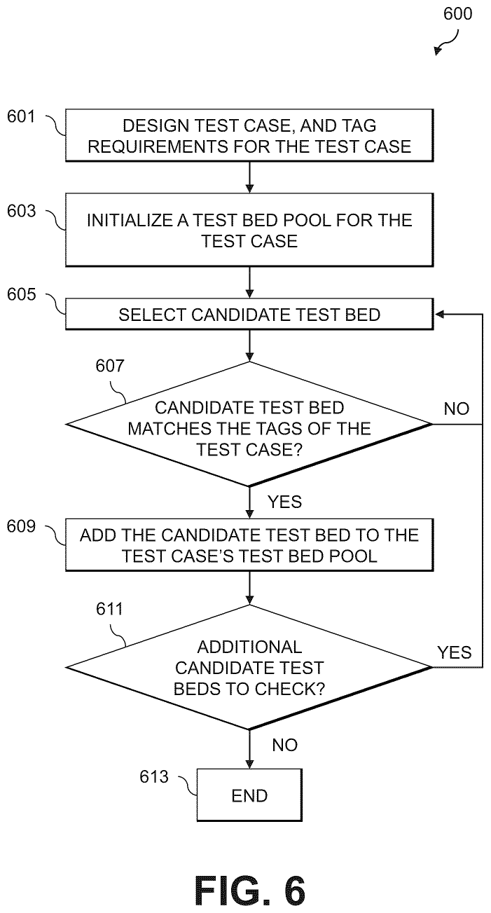

FIG. 6 shows a process flow 600 for creating test bed pools. In step 601, a test case is designed and test bed requirements (e.g., hardware, software and configuration requirements or other limitations) for the test case are tagged. In step 603, a test bed pool for the test case is initialized. A candidate test bed is selected in step 605. In step 607, a determination is made as to whether the candidate test bed selected in step 605 matches the tags (e.g., the test bed requirements) of the test case. If the result of the step 607 determination is no, the process flow 600 returns to step 605 to select another candidate test bed. If the result of the step 607 determination is yes, the candidate test bed is added to the test case's test bed pool in step 609. In step 611, a determination is made as to whether there are additional candidate test beds to check. If the result of the step 611 determination is yes, then the process flow 600 returns to step 605. If the result of the step 611 determination is no, then the process flow 600 ends in step 613. In some embodiments, the step 611 determination may include determining whether the test bed pool for the test case already includes at least a threshold number of test beds. If so, the process flow 600 may end in step 613 even if there are additional candidate test beds to check. The process flow 600 may be repeated for additional test cases as desired. In some embodiments, the process flow 600 is performed for each test case. In other embodiments, the process flow 600 is only performed for some test cases (e.g., test cases having some threshold importance or priority, test cases which have test bed requirement tags, etc.). The process flow 600 may be implemented or run prior to test execution (e.g., prior to or as part of generating a testing plan).

Test bed pools allows mapping of test cases to more available test beds, which will increase the attempt rate for test cases as compared to the example of FIG. 4, where each of the test cases 401 is dependent on a separate one of the test beds 405. This is illustrated in the FIG. 5 mapping of test cases 501 to test bed pools 503, where each of the test bed pools 503 includes at least one of the test beds 505. Further, the dependency degree of a test bed may also be considered to maximize or improve test bed resource utilization rate as will be discussed in further detail below.

The creation of test bed pools for test cases provides a first level of improvements, which smart test execution planning providing additional improvements at a second level. As mentioned above, smart test case execution planning has a goal of running important test cases at a higher priority. Test cases may have test bed tags that specify test bed requirements (e.g., hardware, software and configuration requirements and other limitations). Test cases may also have test case property tags, where such test case property tags may be used to determine prioritization or importance of test cases. Various types of test case properties may be tagged to test cases. As an example, a test case which has never passed before may have a test case property tag of “never passes.” As another example, an important or high priority test case may have a test case property tag of “benchmark,” a test case with the most encountered bugs may have a test case property tag of “most bugs,” etc. Various other examples of test case property tags will be described below.

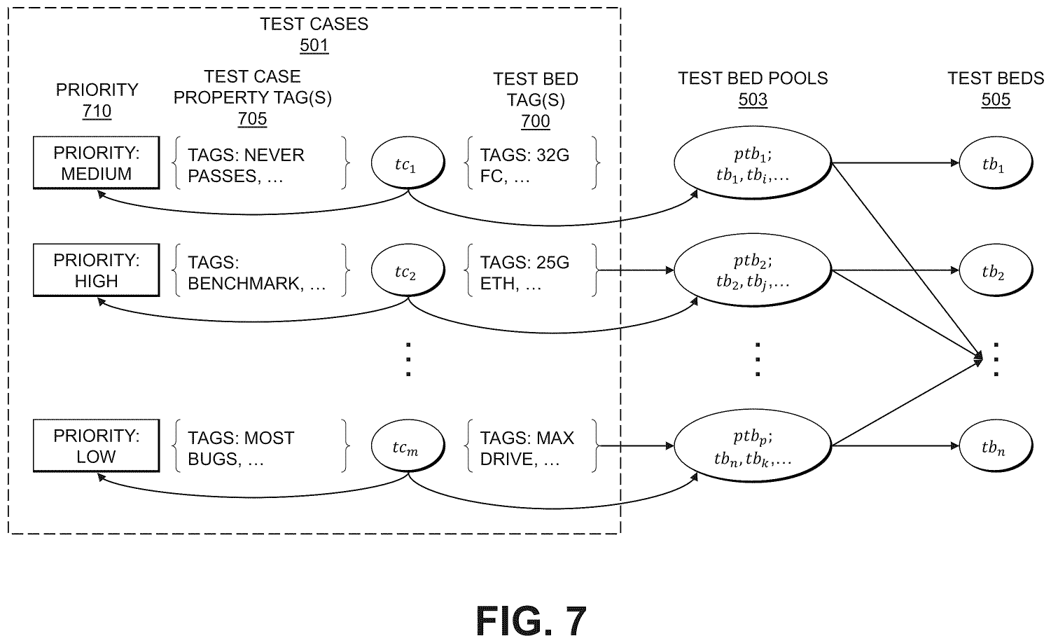

FIG. 7 shows sets of test bed tags 700 and test case property tags 705 which are associated with respective ones of the test cases 501 which are assigned to the test bed pools 503, where each of the test bed pools 503 includes at least one of the test beds 505. Each of the test cases 501 also has an associated priority 710, which may be determined based on its set of test case property tags 705. In some cases the test bed tags 700 and test case property tags 705 are selected from a set of predefined tags (e.g., they are limited to the set of predefined tags for all test cases 501). In other embodiments, custom or user-defined tags may be used for test bed tags 700 and/or test case property tags 705, or combinations of predefined and custom or user-defined tags may be used for test bed tags 700 and/or test case property tags 705.

To achieve the goal of smart test execution planning, it is desired to increase the test case attempt rate and ensure that important or high priority test cases are executed first or earlier in the test execution process. Illustrative embodiments provide technical solutions for finding optimal matches between test cases and test beds, and for determining test case execution order. It should be noted that for a test case, its tags may change along the test life cycle. For example, a test case may have a test case property tag of “never passes” if it has not passed in previous test cycles. If that test case passes in a current test cycle, however, the “never passes” tag will be removed for subsequent test cycles. Thus, the priority of a test case is not necessarily fixed.

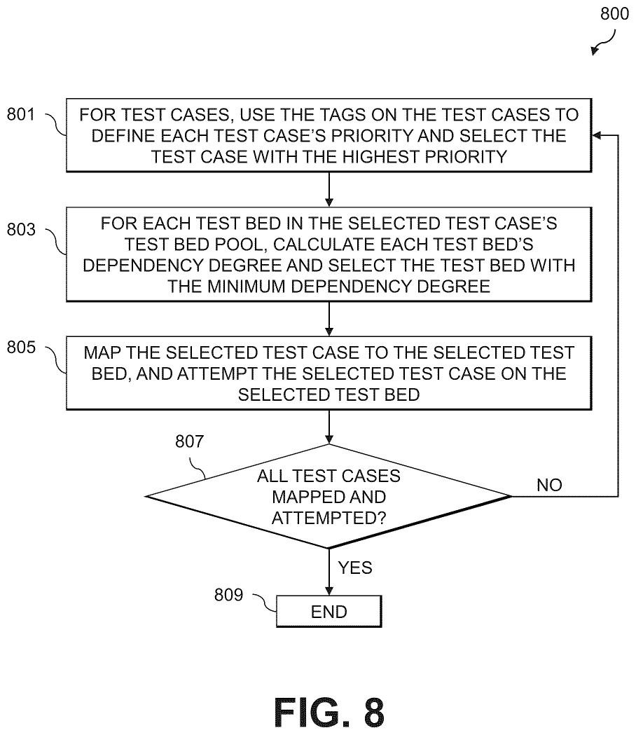

FIG. 8 shows a process flow 800 for formulating a test execution plan. The process flow 800 begins with step 801, where the test case property tags on test cases are used to define each test case's priority, and where the test case with the highest priority is found. In step 803, for each test bed in the selected test case's test bed pool, each test bed's dependency degree is calculated and the test bed with the minimum dependency degree is selected. The selected test case is then mapped to the selected test bed in step 805. The selected test case is then attempted on the selected test bed. In step 807, a determination is made as to whether all test cases have been mapped and attempted. If the result of the step 807 determination is no, the process flow 800 returns to step 801 and the test case with the highest priority (among the test cases which have not been attempted) is selected. If the result of the step 807 determination is yes, the process flow 800 ends in step 809.

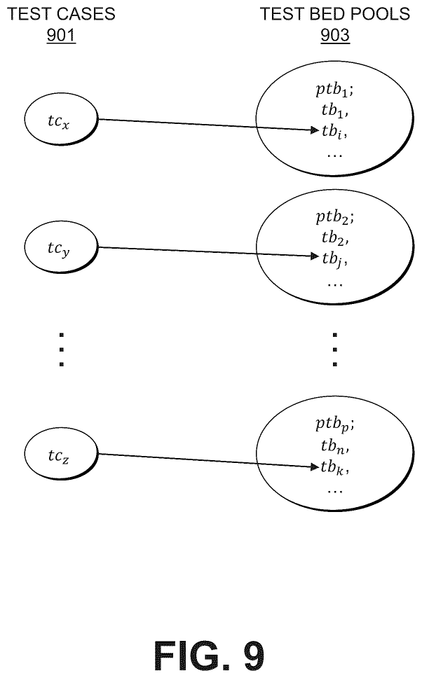

FIG. 9 shows an example test execution map produced using the process flow 800, where a set of test cases 901 are mapped to test beds within a set of test bed pools 903. In the FIG. 9 example, the test case tcₓ is mapped to the test bed tbt in the test bed pool ptb₁, the test case tc_{y} is mapped to the test bed tbⱼ in the test bed pool ptb₂, . . . and the test case tc_{z} is mapped to the test bed tbₖ in the test bed pool ptbₚ. The test case tcₓ is assumed to be the most important or highest priority test case, and the test bed tbt has the minimum dependency degree in the test bed pool ptbᵢ that the test case tcₓ is mapped to. The case tc_{y} is assumed to be the next-most important or next-highest priority test case, and the test bed tbⱼ has the minimum dependency degree in the test bed pool ptb₂ that the test case tc_{y} is mapped to, and so on. The test cases tcₓ, tc_{y} and tc_{z} may be executed in parallel or in a sequential order, depending on the test execution duration, and [x, y, . . . z]∈[1, 2, . . . m].

Test cases may be continually generated along the product development life cycle. Determining how to execute as many test cases, including more important test cases, is a significant technical problem in project management. The technical solutions described herein provide an approach for generating smart test execution plans which improve test execution from two levels (e.g., through the creation of test bed pools, and through intelligent ordering and mapping of test cases to test beds in the test bed pools) to achieve the goals of increasing test case attempt rate and prioritizing important test cases for execution first.

In some embodiments, the technical solutions for smart test plan generation comprehensively consider multiple important factors, including but not limited to test case priority (e.g., based on test case property tags) and test bed dependency degree. The technical solutions may use a dynamic analytic hierarchy process (AHP) to calculate the priorities of test cases, and may use linear programming mathematical modeling techniques to generate test execution plans (e.g., an ordering of test cases and assignment of test cases to test beds within test bed pools that the test cases are mapped to).

In the description below, TC is used to denote a test case set, where TC=[tc₁, tc₂, . . . tcₘ]. TB is used to denote a test bed set, where TB=[tb₁, tb₂, . . . tbₙ]. Test tags are denoted as {[hw], [sw]}, where [hw] denotes the test bed tags and [sw] denotes the test case property tags. The test bed tags [hw] represent test case requirements for test beds (e.g., hardware, software and configuration requirements and other limitations). The test case property tags [sw] represent test case “soft” requirements or test case properties, where [sw] tags may be updated along a test case's life cycle. ptb(tcᵢ) denotes the test bed pool for test case tcᵢ, d(tbⱼ) denotes the dependency degree of test bed tbⱼ, and ptc(tbⱼ) denotes the test case pool for test bed tbⱼ

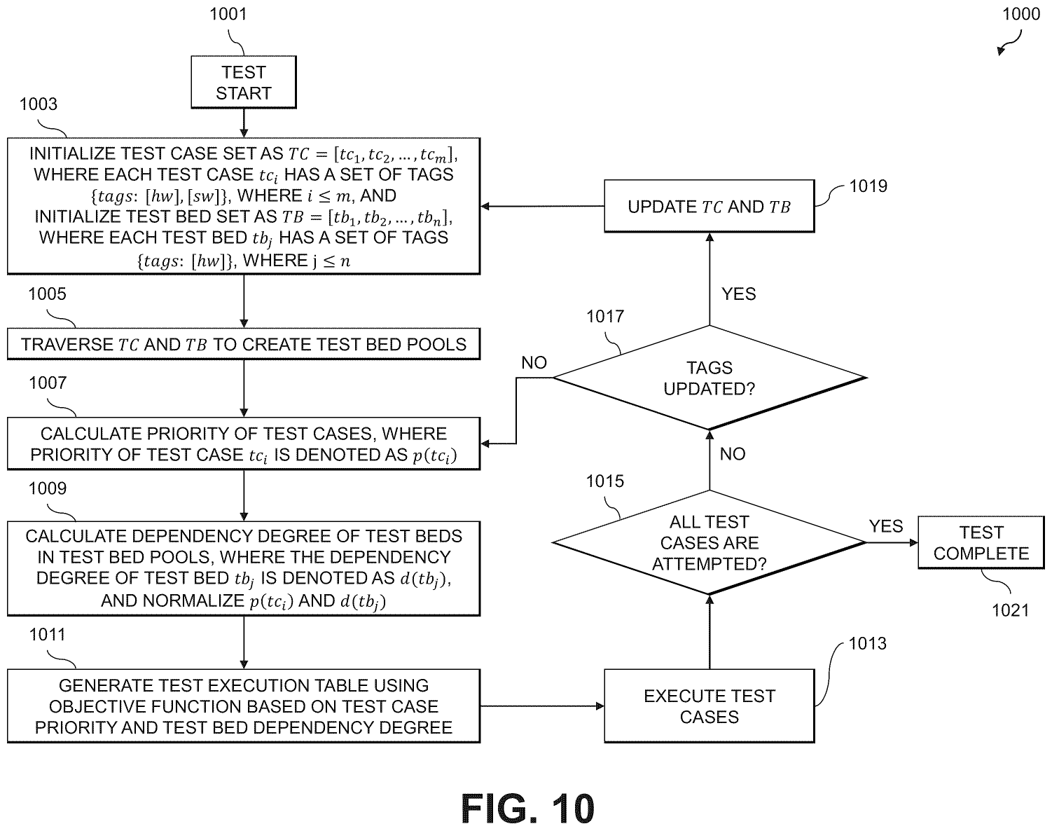

FIG. 10 shows a process flow 1000 for generating and executing a testing plan. The process flow 1000 begins in step 1001 where testing starts (e.g., there is a request to generate and execute a testing plan). In step 1003, the test case set TC and test bed set TB are initialized. In step 1005, TC and TB are traversed to create test bed pools (e.g., one test bed pool for each test case in the TC). If the [hw] tags of a test bed tbⱼ match the [hw] tags of a test case tcᵢ, then tbⱼ is added to ptb(tcᵢ) (e.g., the test bed pool for tcᵢ).

The priority of test cases in TC are calculated in step 1007 based on the [sw] tags of the test cases. As discussed above, various test case property tags may be predefined for the test cases, such as: “never passes” denoting a test case which has never passed before; “most bugs” denoting a test case that finds many bugs; “benchmark” denoting a test case that ensures one or more basic product functions work as expected; “new feature coverage” denoting a test case designed for one or more new product features; “regression” denoting a test case for regression testing; and “GR gate” denoting a test case that is a golden run (GR) gate test which needs to be attempted before the golden run. Each of the [sw] tags may have an associated weight value. Assuming there are r different [sw] tags, the weight values may be represented as W=[w₁, w₂, . . . wᵣ], where Σ₁^{r}wᵢ=1.

In some embodiments, the weights may be distributed evenly (e.g., each weight is assigned the same value). In other embodiments, the weights may be dynamically assigned and updated throughout different testing stages, as the meaning or importance of different ones of the [sw] tags may be different in different testing stages. For example, in the whole test life cycle across testing stages, test cases with the “benchmark” tag are important and are expected to be 100% attempted. At earlier test stages, test cases with “regression,” “most bugs” and “new feature coverage” tags may be more important than other test cases without those tags, although there may be exceptions such as test cases with the “benchmark” tag. At later test stages, test cases with “never passes” or “GR gate” tags may be more important than other test cases without those tags, although again there may be exceptions such as test cases with the “benchmark” tag. It should be appreciated that this is just an example of the differing importance or priority of test case property tags, and that other embodiments may use various other test case property tags and test case property tag weighting in addition to or in place of one or more of these examples.

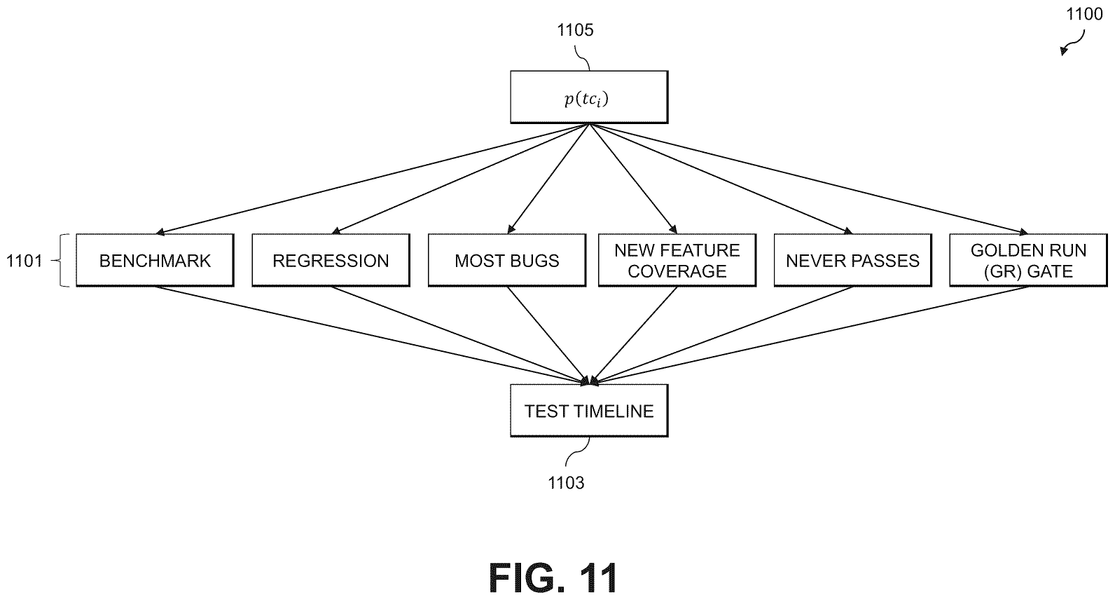

AHP is a structured technique for organizing and analyzing complex decisions, and represents an accurate approach for quantifying the weights of decision criteria such as the test case property tags. Test case property tag analysis gives insight that conditions vary over time, such that making a good decision regarding test case priority involves judgments of what is more likely or more preferred over different time periods (e.g., different testing stages). FIG. 11 shows an AHP architecture 1100 used to calculate weights for a set of [sw] tags 1101, where such weights may vary over a test timeline 1103 for determining the priority of test case tcᵢ 1105, p(tcᵢ). In some embodiments, a time-based AHP algorithm is used to handle dynamic decisions. The time-based AHP algorithm utilizes a judgment matrix in dynamic form, represented as:

$$A ( t ) = [ \begin{matrix}{a}_{11} ( t ) & … & {a}_{1 n} ( t ) \\ ⋮ & ⋱ & ⋮ \\ {a}_{n 1} ( t ) & … & {a}_{nn} ( t )\end{matrix} ]$$

where aᵢⱼ>0, aᵢⱼ(t)=aᵢⱼ⁻¹(t), and aᵢⱼ

$$( t ) = \frac{{w}_{i} ( t )}{{w}_{j} ( t )} .$$

The geometric mean of each row vector of matrix A(t) is determined (e.g., using a square root method) and normalized. The weight of each tag and the eigenvector W is thus obtained according to:

$${w}_{i} = \overline{{w}_{i}} / {\sum }_{1}^{n} {w}_{i} , W = \{ \begin{matrix}\begin{matrix}{w}_{1} \\ ⋮\end{matrix} \\ {w}_{n}\end{matrix} \}$$

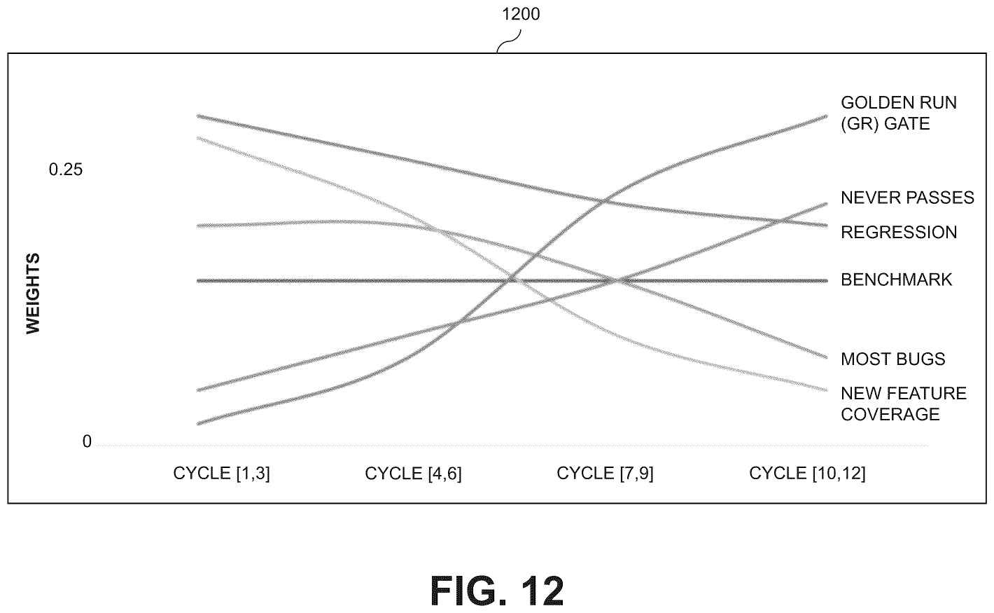

Suppose that there are a total of 12 test cycles planned for a test life cycle. FIG. 12 shows a plot 1200 of the expected weight update trends during the test life cycle across the 12 test cycles for the [sw] tags “GR gate,” “never passes,” “regression,” “benchmark,” “most bugs” and “new feature coverage.” Returning to the process flow 1000, the priority p(tcᵢ) for test case tcᵢ is calculated in step 1007 as the sum of its test case property tags' weights.

The process flow 1000 continues with step 1009, calculating the dependency degrees of test beds in the test bed pools. Each test case tcᵢ has an associated test bed pool, ptb(tcᵢ). A given test bed, however, may be added to multiple test bed pools. Thus, each test bed tbⱼ has an associated test case pool ptc(tbⱼ). To ensure that important test cases are executed first or earlier in the test life cycle, two conditions should be met: important test cases should have higher priority (e.g., an important test case tcᵢ has higher p(tcᵢ) than less important test cases); and test beds with minimal dependency degree should be selected for important test cases (e.g., for the most important test case tcᵢ, the test bed tbⱼ in ptb(tcᵢ) with minimal dependency degree is assigned, where the minimal dependency degree means that the test bed tbⱼ is more free or stable than other test beds in ptb(tcᵢ)). The dependency degree of test bed tbⱼ, d(tbⱼ) may be determined according to the following equation:

$$d ( t {b}_{j} ) = \frac{size of p t c ( t {b}_{j} )}{m}$$

A Z-score normalization method is used to normalize p (tcᵢ) and d (tbⱼ) according to the following equations:

$${p ( t {c}_{i} )}^{′} = \frac{p ( t {c}_{i} ) - \overline{p ( t {c}_{ι} )}}{s} and \overline{p ( t {c}_{ι} )} = \frac{1}{m} {\sum }_{1}^{m} p ( t {c}_{i} ) , \\ s = \sqrt{\frac{1}{m - 1} {\sum }_{1}^{m} (} p ( t {c}_{i} ) - {\overline{p ( t {c}_{ι} )}}^{2} )$$

$${d ( t {b}_{i} )}^{′} = \frac{d ( t {b}_{j} ) - \overline{d ( {tb}_{J} )}}{s} and \overline{d ( {tb}_{J} )} = \frac{1}{n} {\sum }_{1}^{n} d ( t {b}_{j} ) , \\ s = \sqrt{\frac{1}{n - 1} {\sum }_{1}^{n} ( d} ( {tb}_{j} ) - {\overline{d ( {tb}_{J} )}}^{2} )$$

The process flow 1000 continues with step 1011, generating a test execution table using an objective function that is based on test case priority and test bed dependency degree. Linear programming mathematical modeling techniques are used in some embodiments to determine the optimal test execution process order. In some embodiments, the following objective function is used:

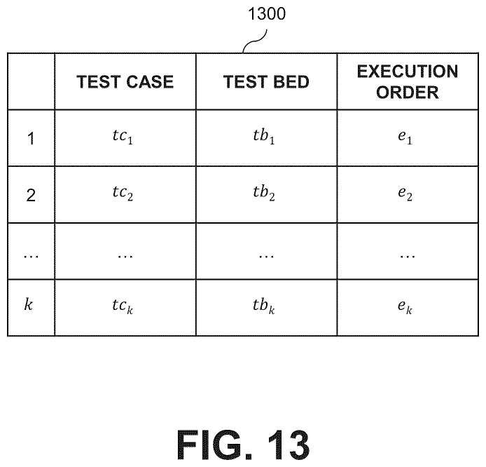

max E=ωₚ*p(tcᵢ)′+ω_{d}*(1−d(tbⱼ)′)

where ωₚ and ω_{d} denote weights of p(tcᵢ) and d(tbⱼ), respectively, and where ωₚ+ω_{d}=1. By tuning the weights, better overall balancing results may be achieved. FIG. 13 shows an example test execution table 1300. In the test execution table 1300, e₁>e₂> . . . >eₖ.

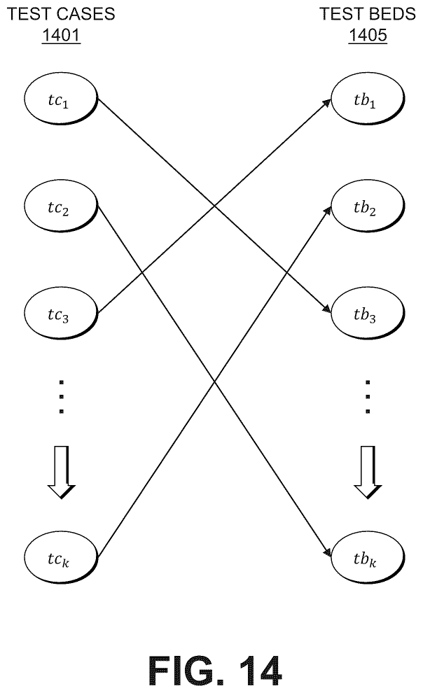

In step 1013, the test execution table is followed to start the test life cycle and begin executing test cases. Test cases may run in parallel, sequentially, or combinations of in parallel and sequentially according to exclusivity. The test execution table may be refreshed when test cases are attempted. FIG. 14 shows an example test case execution order for test cases 1401, denoted test cases tc₁, tc₂, tc₃, . . . tCₖ, on test beds 1405, denoted test beds tb₁, tb₂, tb₃, . . . tbₖ.

As the test cases are executed in step 1013, the step 1015 determination may be performed. In some embodiments, the step 1015 determination is performed continually, or after each test case is attempted. The step 1015 determination may also or alternatively be performed periodically on some defined schedule, in response to explicit user requests, in response to detecting some designated conditions (e.g., that testing has moved from one testing stage to another, such that weight or tag updates should be performed), etc. In step 1015, a determination is made as to whether all test cases in the test execution plan have been attempted. If the result of the step 1015 determination is no, the process flow 1000 proceeds to step 1017 where a determination is made as to whether any of the tags for any of the test cases in TC or test beds in TB are to be updated. If the result of the step 1017 determination is yes, then the process flow 1000 proceeds to step 1019 where TC and TB are updated. Following step 1019, the process flow 1000 may return to step 1003. If the result of the step 1017 determination is no, then the process flow 1000 returns to step 1007. The process flow 1000 may continue until the result of the step 1015 determination is yes, at which point the process flow 1000 proceeds to step 1021 where testing is complete.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for generating testing plans including execution order for test cases and mapping of test cases to test bed pools will now be described in greater detail with reference to FIGS. 15 and 16. Although described in the context of information processing system 100, these platforms may also be used to implement at least portions of other information processing systems in other embodiments.

FIG. 15 shows an example processing platform comprising cloud infrastructure 1500. The cloud infrastructure 1500 comprises a combination of physical and virtual processing resources that may be utilized to implement at least a portion of the information processing system 100 in FIG. 1. The cloud infrastructure 1500 comprises multiple virtual machines (VMs) and/or container sets 1502-1, 1502-2, . . . 1502-L implemented using virtualization infrastructure 1504. The virtualization infrastructure 1504 runs on physical infrastructure 1505, and illustratively comprises one or more hypervisors and/or operating system level virtualization infrastructure. The operating system level virtualization infrastructure illustratively comprises kernel control groups of a Linux operating system or other type of operating system.

The cloud infrastructure 1500 further comprises sets of applications 1510-1, 1510-2, . . . 1510-L running on respective ones of the VMs/container sets 1502-1, 1502-2, . . . 1502-L under the control of the virtualization infrastructure 1504. The VMs/container sets 1502 may comprise respective VMs, respective sets of one or more containers, or respective sets of one or more containers running in VMs.

In some implementations of the FIG. 15 embodiment, the VMs/container sets 1502 comprise respective VMs implemented using virtualization infrastructure 1504 that comprises at least one hypervisor. A hypervisor platform may be used to implement a hypervisor within the virtualization infrastructure 1504, where the hypervisor platform has an associated virtual infrastructure management system. The underlying physical machines may comprise one or more distributed processing platforms that include one or more storage systems.

In other implementations of the FIG. 15 embodiment, the VMs/container sets 1502 comprise respective containers implemented using virtualization infrastructure 1504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing system 100 may each run on a computer, server, storage device or other processing platform element. A given such element may be viewed as an example of what is more generally referred to herein as a “processing device.” The cloud infrastructure 1500 shown in FIG. 15 may represent at least a portion of one processing platform. Another example of such a processing platform is processing platform 1600 shown in FIG. 16.

The processing platform 1600 in this embodiment comprises a portion of information processing system 100 and includes a plurality of processing devices, denoted 1602-1, 1602-2, 1602-3, . . . 1602-K, which communicate with one another over a network 1604.

The network 1604 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1602-1 in the processing platform 1600 comprises a processor 1610 coupled to a memory 1612.

The processor 1610 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1612 may comprise random access memory (RAM), read-only memory (ROM), flash memory or other types of memory, in any combination. The memory 1612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1602-1 is network interface circuitry 1614, which is used to interface the processing device with the network 1604 and other system components, and may comprise conventional transceivers.

The other processing devices 1602 of the processing platform 1600 are assumed to be configured in a manner similar to that shown for processing device 1602-1 in the figure.

Again, the particular processing platform 1600 shown in the figure is presented by way of example only, and information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for generating testing plans including execution order for test cases and mapping of test cases to test bed pools as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, testing plans, testing tasks, testing actions, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured to perform steps of:
identifying a plurality of test cases and a plurality of test beds on which the plurality of test cases are configured to run, the plurality of test beds comprising information technology assets of an information technology infrastructure;
creating a plurality of test bed pools, wherein each of the plurality of test bed pools is associated with one of the plurality of test cases and comprises at least one of the plurality of test beds, and wherein a given one of the plurality of test bed pools associated with a given one of the plurality of test cases comprises at least a subset of the plurality of test beds having test bed configurations matching one or more test bed specifications of the given test case;
determining a priority level of each of the plurality of test cases, wherein a given priority level of the given test case is determined based at least in part on one or more test case property specifications of the given test case;
determining a dependency degree of each of the plurality of test beds, wherein a given dependency degree for a given one of the plurality of test beds is determined based at least in part on a number of the plurality of test bed pools that the given test bed is part of, generating a testing plan for testing a given product, the testing plan comprising a test case execution order for the plurality of test cases and a mapping of the plurality of test cases to the plurality of test beds, wherein the test case execution order is determined based at least in part on the priority levels of the plurality of test cases, and wherein the mapping of the plurality of test cases to the plurality of test beds is determined based at least in part on the dependency degrees of the plurality of test beds; and
executing the testing plan for testing the given product.

2. The apparatus of claim 1 wherein the given product comprises software configured to run on the information technology assets of the information technology infrastructure.

3. The apparatus of claim 1 wherein a given test bed configuration for a given one of the plurality of test beds comprises at least one of a hardware and a software configuration of a given one of the information technology assets of the information technology infrastructure on which the given test bed runs.

4. The apparatus of claim 3 wherein the one or more test bed specifications of the given test case comprise at least one of one or more hardware configuration requirements and one or more software configuration requirements.

5. The apparatus of claim 1 wherein the one or more test case property specifications of the given test case specify a type of testing performed during the given test case.

6. The apparatus of claim 5 wherein the type of testing comprises at least one of regression testing, new feature coverage testing, and benchmark testing.

7. The apparatus of claim 1 wherein the one or more test case property specifications of the given test case specify one or more results of previous attempts to perform the given test case.

8. The apparatus of claim 7 wherein the one or more results of the previous attempts to perform the given test case indicate at least one of: whether the given test case has passed during the previous attempts to perform the given test case; and bugs encountered during the previous attempts to perform the given test case.

9. The apparatus of claim 1 wherein the given priority level for the given test case is determined as a weighted average of weights assigned to the one or more test case property specifications.

10. The apparatus of claim 9 wherein the given priority level is determined utilizing a time-based analytic hierarchy process which takes into account a current one of a plurality of testing stages of a test life cycle of the testing plan.

11. The apparatus of claim 10 wherein values of the weights assigned to the one or more test case property tag specifications are dynamically updated at different ones of the plurality of testing stages of the test life cycle of the testing plan.

12. The apparatus of claim 10 wherein the time-based analytic hierarchy process utilizes a dynamic judgment matrix, and wherein the weighted average is computed by determining a geometric mean of each row vector of the dynamic judgment matrix and normalizing values of the weights assigned to the one or more test case property specifications.

13. The apparatus of claim 1 wherein generating the testing plan for testing the given product comprises normalizing the priority levels and the dependency degrees utilizing a Z-score normalization algorithm.

14. The apparatus of claim 13 wherein generating the testing plan for testing the given product comprises utilizing a linear programming mathematical model comprising an objective function that comprises a weighted sum of the normalized priority levels and dependency degrees.

15. A computer program product comprising a non-transitory processor-readable storage medium having stored therein program code of one or more software programs, wherein the program code when executed by at least one processing device causes the at least one processing device to perform steps of:
identifying a plurality of test cases and a plurality of test beds on which the plurality of test cases are configured to run, the plurality of test beds comprising information technology assets of an information technology infrastructure;
creating a plurality of test bed pools, wherein each of the plurality of test bed pools is associated with one of the plurality of test cases and comprises at least one of the plurality of test beds, and wherein a given one of the plurality of test bed pools associated with a given one of the plurality of test cases comprises at least a subset of the plurality of test beds having test bed configurations matching one or more test bed specifications of the given test case;
determining a priority level of each of the plurality of test cases, wherein a given priority level of the given test case is determined based at least in part on one or more test case property specifications of the given test case;
determining a dependency degree of each of the plurality of test beds, wherein a given dependency degree for a given one of the plurality of test beds is determined based at least in part on a number of the plurality of test bed pools that the given test bed is part of;
generating a testing plan for testing a given product, the testing plan comprising a test case execution order for the plurality of test cases and a mapping of the plurality of test cases to the plurality of test beds, wherein the test case execution order is determined based at least in part on the priority levels of the plurality of test cases, and wherein the mapping of the plurality of test cases to the plurality of test beds is determined based at least in part on the dependency degrees of the plurality of test beds; and
executing the testing plan for testing the given product.

16. The computer program product of claim 15 wherein the given priority level for the given test case is determined as a weighted average of weights assigned to the one or more test case property specifications, and wherein the given priority level is determined utilizing a time-based analytic hierarchy process which takes into account a current one of a plurality of testing stages of a test life cycle of the testing plan.

17. The computer program product of claim 16 wherein values of the weights assigned to the one or more test case property tag specifications are dynamically updated at different ones of the plurality of testing stages of the test life cycle of the testing plan.

18. A method comprising:
identifying a plurality of test cases and a plurality of test beds on which the plurality of test cases are configured to run, the plurality of test beds comprising information technology assets of an information technology infrastructure;
creating a plurality of test bed pools, wherein each of the plurality of test bed pools is associated with one of the plurality of test cases and comprises at least one of the plurality of test beds, and wherein a given one of the plurality of test bed pools associated with a given one of the plurality of test cases comprises at least a subset of the plurality of test beds having test bed configurations matching one or more test bed specifications of the given test case;
determining a priority level of each of the plurality of test cases, wherein a given priority level of the given test case is determined based at least in part on one or more test case property specifications of the given test case;
determining a dependency degree of each of the plurality of test beds, wherein a given dependency degree for a given one of the plurality of test beds is determined based at least in part on a number of the plurality of test bed pools that the given test bed is part of;
generating a testing plan for testing a given product, the testing plan comprising a test case execution order for the plurality of test cases and a mapping of the plurality of test cases to the plurality of test beds, wherein the test case execution order is determined based at least in part on the priority levels of the plurality of test cases, and wherein the mapping of the plurality of test cases to the plurality of test beds is determined based at least in part on the dependency degrees of the plurality of test beds; and
executing the testing plan for testing the given product;
wherein the method is performed by at least one processing device comprising a processor coupled to a memory.

19. The method of claim 18 wherein the given priority level for the given test case is determined as a weighted average of weights assigned to the one or more test case property specifications, and wherein the given priority level is determined utilizing a time-based analytic hierarchy process which takes into account a current one of a plurality of testing stages of a test life cycle of the testing plan.

20. The method of claim 19 wherein values of the weights assigned to the one or more test case property tag specifications are dynamically updated at different ones of the plurality of testing stages of the test life cycle of the testing plan.
